(19) United States
(12) Patent Application Publication
(10) Pub. No.: US 2002/0087553 A1
(43) Pub. Date: Jul. 4, 2002

(54) System for permitting access to a database

(76) Inventors: Satoshi Kitahara, Tokyo (JP); Kenichi Sugasawara, Tokyo (JP); Kenji Otsuka, Tokyo (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 10/014,063

(22) Filed: Dec. 10, 2001

(30) Foreign Application Priority Data
Dec. 28, 2000 (JP) 2000-403071

(51) Int. Cl. G06F 7/00

(52) U.S. Cl. 707/10

(57) ABSTRACT

A system for permitting access to a database, in which labor is saved and privacy of individuals is not invaded when the database is accessed from the outside. Access key information is used as a key when requesting access to the database in which personal credit information is stored. Access key information and conditions under which access is permitted are also stored in the database. When a request for access is made, inputted access key information is checked against the access key information stored in the database. When the inputted access key information matches the access key information stored in the database, and when the conditions under which access is permitted are satisfied, access to the database is permitted.

### BACKGROUND OF THE INVENTION

1. Field of the Invention

The present invention relates to a system for permitting access to a database, a method of permitting access to the database, a database manager, a consumer client and a corporate server, and particularly to a system for permitting access to personal credit information stored in a database that is disposed in a personal credit information agency, a method of permitting access to the database, a database manager for managing the database, a consumer client and a corporate server.

2. Description of the Related Art

A personal credit information agency collects personal credit information (information relating to credit, such as terms of contract, state of repayment, etc.) from corporate members and stores it in a database, and provides the personal credit information in response to inquiries from the corporate members. On the assumption that the personal credit information is read by the corporate members, the information is made to correspond to a search key for identifying an individual and is stored in the database of the personal credit information agency, thereby the personal credit information can be searched with the search key.

The corporate member uses the personal credit information to easily and suitably judge credit solvency thereby delays in repayment irrecoverable debts or the like can be prevented in advance.

Conventionally, in order for the corporate member to search the personal credit information of an individual, the corporate member has been required to use an attribute (e.g., name, date of birth, etc.) of an individual as a search key to identify the individual. Thus, the corporate member verifies the attribute (name, date of birth, etc.) of the individual who is the target of the search, and requests a public certificate as its proof. Thus it has been difficult to save labor in searching the personal credit information. There have also been by a false declaration, a mistake at the time of confirmation, or the like, personal credit information of the target person is not obtained or personal credit information of another person different from the target person is searched. Particularly, in respect to dealings on the Internet, since it is difficult to request a public certificate, the verification of an attribute (name, date of birth, etc.) of the individual who is the target of the search becomes insufficient, and it has been difficult to prevent an intentional false declaration.

It has also been difficult to reduce the burden placed on a consumer applying for a credit contract. A lot of time is expended before the contract is completed because the identity of the consumer must be verified, and the consumer is requested to present a public certificate. There has also been the problem that personal credit information of a person different from the target person is erroneously searched and the credit state of the target person is erroneously judged, whereby the opportunity to make a credit contract is lost.

Moreover, since the search of personal credit information by a corporate member can be made only if an attribute (name, date of birth, etc.) for identifying an individual is known, there has also been the problem that personal credit information has been used for purposes other than examination at the conclusion of a credit contract, which is a common condition of use of the personal credit information.

### SUMMARY OF THE INVENTION

The present invention has been devised to solve the above problems. It is an object of the present invention to provide a system permitting access to a database, a method of permitting access to the database, a database manager, a consumer client and a corporate server, wherein labor is saved and privacy of an individual is not invaded.

According to an aspect of the present invention, a system for permitting access to a database is provided, comprising: a database manager, wherein access key information that is used as a key for accessing personal information stored in the database and conditions for permitting access to the database are preset, and when a request for access to the database is made, it is determined whether or not the preset access key information matches the access key information used in the request, with access to the database being permitted when the access key information matches the access key information used in the request and the conditions for permitting access are satisfied; and a setting unit for setting the access key information and the conditions in the database manager.

According to another aspect of the present invention, a method for accessing a database in which personal information is stored is provided, comprising the steps of: presetting access key information that is used as a key for accessing the database and conditions for permitting access to the database; determining, when a request for access is made, whether access key information used in the request matches the preset access key information and whether the conditions for permitting access are satisfied; and permitting access to the database when the access key information used in the request matches the preset access key information and when the conditions for permitting access are satisfied.

According to still another aspect of the present invention, a database manager is provided, comprising: a storage for presetting and storing access key information that is used as a key for accessing the database and conditions for permitting access to the database; a decider for determining, when a request for access is made, whether access key information used in the request matches the preset access key information and whether the conditions for permitting access are satisfied; and a permit device for permitting access to the database when the access key information used in the request matches the preset access key information and when the conditions for permitting access are satisfied.

According to still another aspect of the present invention, a consumer client is provided, comprising: a receiver for receiving from a predetermined agency access key information used in a database manager, wherein access key information that is used as a key for accessing a database and conditions for permitting access to the database are preset in the database manager, with the database manager determining, when a request for access is made, whether access key information used in the request matches the preset access key information and whether the conditions for permitting access are satisfied, and with the database manager permitting access to the database when the access key information used in the request matches the preset access key information and when the conditions for permitting access are satisfied; and a transmitter for transmitting the access key information received from the predetermined agency to a corporate server.

According to still another aspect of the present invention, a corporate server is provided, comprising: a receiver for receiving from a consumer client access key information used in a database manager, wherein access key information that is used as a key for accessing a database and conditions for permitting access to the database are preset in the database manager, with the database manager determining, when a request for access is made, whether access key information used in the request matches the preset access key information and whether the conditions for permitting access are satisfied, and with the database manager permitting access to the database when the access key information used in the request matches the preset access key information and when the conditions for permitting access are satisfied; and an access device for accessing the database by using the access key information received from the consumer client.

According to the present invention, the access key information and the conditions for permitting access to the database are predetermined, and when a request for access to the database is made, it is determined whether or not the preset access key information matches the access key information used in the request and whether the conditions for permitting access to the database are satisfied, with access to the database being permitted when the access key information matches the access key information used in the request and the conditions for permitting access are satisfied. Because the conditions are used in addition to the access key information in this manner, the conditions are determined so that it is not possible for a corporate member of whom it is not desired to read the personal information of a certain person to search that personal information. Moreover, because the personal information to be searched is uniquely specified by the access key information, labor is saved and the database can be accessed from the outside without the privacy of individuals being invaded. In addition to general information of an individual, personal credit information can be used as the personal information.

### BRIEF DESCRIPTION OF THE DRAWINGS

FIG. 1 is a block diagram of a system according to a first embodiment of the present invention.

FIG. 2 is a block diagram of a server in the first embodiment.

FIG. 3 is a block diagram of a consumer member client in the first embodiment.

FIG. 4 is a block diagram of a corporate member server in the first embodiment.

FIG. 5A and FIG. 5B are flowcharts showing a processing routine when access key information is acquired from the server.

FIG. 6 is a flowchart showing a processing routine when a consumer member presents access key information to a corporate member.

FIG. 7A and FIG. 7B are flowcharts showing processing routines when the corporate member acquires personal credit information from the server.

FIG. 8 is a flowchart showing a processing routine when access key information is acquired from a server in a second embodiment.

FIG. 9 is a flowchart showing a processing routine when a consumer member presents access key information to a corporate member in the second embodiment.

### DESCRIPTION OF THE PREFERRED EMBODIMENTS

Hereinafter, a first embodiment, in which the present invention is applied to a system for permitting access to a database in which personal credit information of consumer members is stored, will be described in detail with reference to the drawings.

According to the present embodiment, information that is used as a key when accessing a database (hereinafter, “access key information”) in which personal credit information is stored as personal information and conditions for permitting access to the database (hereinafter, sometimes referred to as “access permission conditions”) are stored in a server in accordance with a setting of a consumer member. When a corporate member requests access, access to specific personal credit information recorded in the consumer member personal credit information database is permitted when access key information inputted by the corporate member matches the access key information stored in the server and the conditions for permitting access are satisfied.

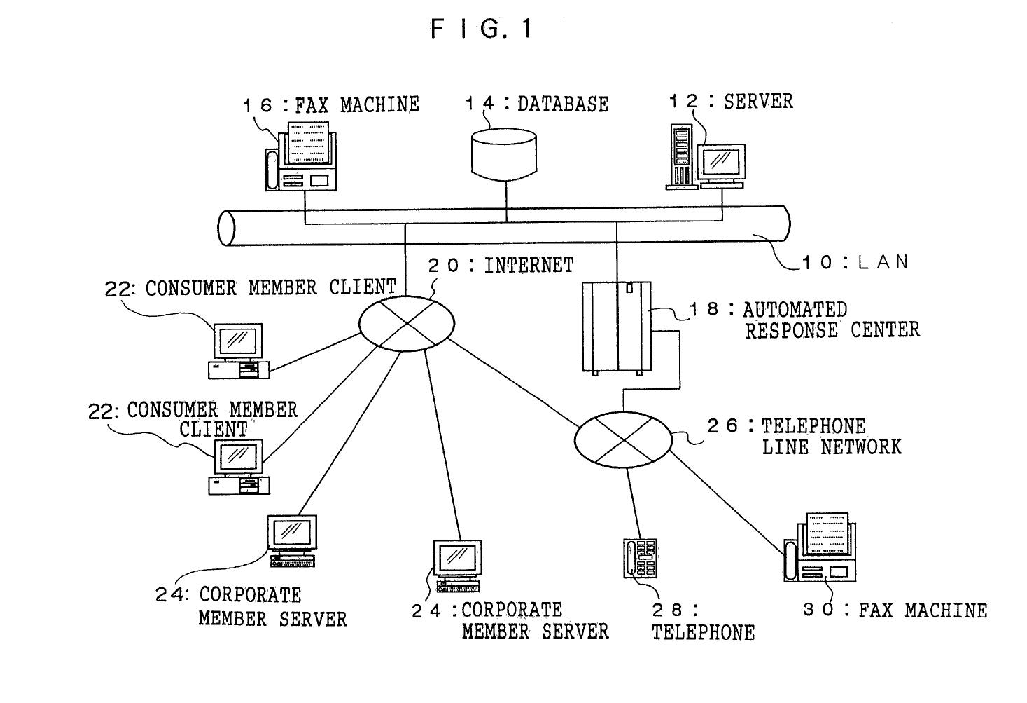

The system in the present embodiment includes, as shown in FIG. 1, a LAN 10 installed in a personal credit information agency. The LAN 10 is connected to a server 12 that serves as a database manager for verifying access, updating and searching the database, a database 14 for storing personal credit information of consumer members, a facsimile machine 16, an automated response center 18 for automatically responding to inquiries by telephone, and other unillustrated electronic equipment such as a computer.

The LAN 10 is connected to a network 20, such as the Internet, through a connecting device (not illustrated)such as a modem, a router or a TA (Terminal Adapter). The network 20 is connected to a consumer member client 22 used, for example, when a consumer member sets access key information and access permission conditions through the connecting device, and to a corporate member server 24 used, for example, when a corporate member requests access to the database. The consumer member client 22 and the corporate member server 24 pre-register IDs and passwords as members with the server 12 through the personal credit information agency to enable access to the server 12.

The network 20 is connected to a telephone 28 and a facsimile machine 30 used by the consumer member and the corporate member through a telephone line network 26 such as a digital telephone network, and is further connected to an unillustrated transmission/reception center (for example, an i-mode center) and a base station provided with an antenna. By using the transmission/reception center and the base station, the server 12, the client and the like can be accessed by using of a portable terminal, such as a portable telephone, in which an Internet browser is installed.

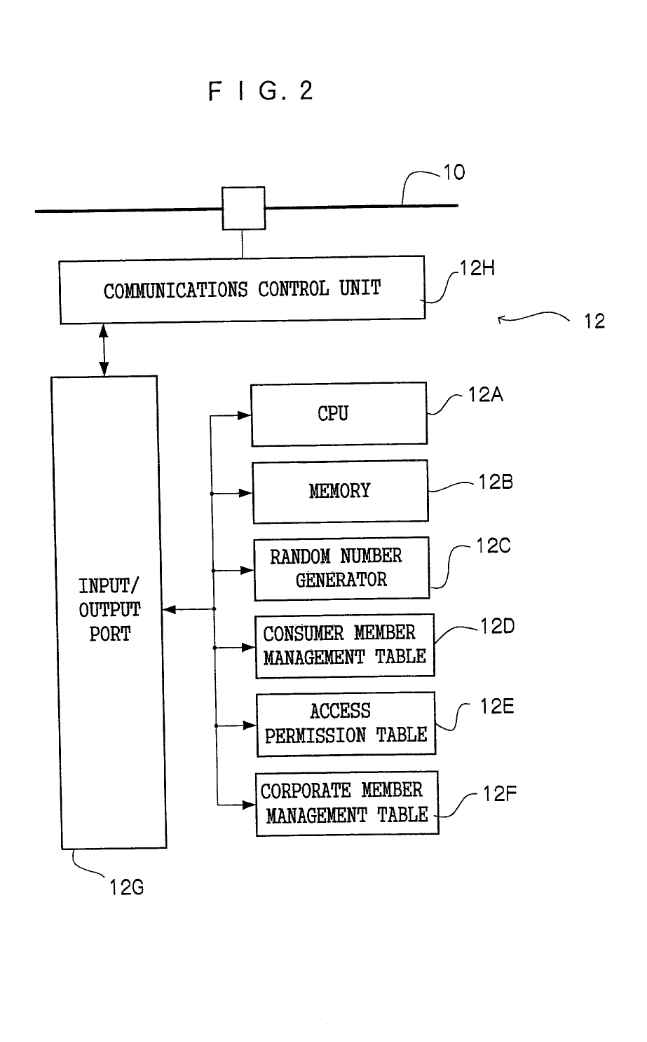

The server 12 includes, as shown in FIG. 2, a CPU (Central Processing Unit) 12A for controlling the entire server, a memory 12B disposed with a ROM in which a program of a processing routine program is stored and a RAM used as a work area when the program is executed, a random number generator 12C for generating a random number used as access key information, a consumer member management table 12D, an access permission table 12E, a corporate member management table 12F, and an input/output port 12G for input/output of data to and from each of the CPU 12A, the memory 12B, the random number generator 12C, and the various tables 12D to 12F. The CPU 12A, the memory 12B, the random number generator 12C, the various tables 12D to 12F and the input/output port 12G are connected to one another through a bus.

The input/output port 12G is connected to the network 10 through a communications control unit 12H for communicating with, through the network 10, the electronic equipment, such as the client, connected to the network 10.

A consumer member ID and a password used for identification are pre-stored in the consumer member management table 12D at the time of entrance registration of a consumer member. At least one of an e-mail address, a facsimile number, and a postal mailing address is also stored in the consumer member management table 12D as a destination to which the access key information is sent. In consideration of the potential for transmission not to be possible due to the destination being busy when only one destination is stored, two or more destinations may be stored so that, when it is not possible to transmit to one destination, transmission may be made to another destination.

In addition to the ID, such as a personal identification number, that is set by the consumer member, physical traits (e.g., voice, face, eyes, fingerprints) unique to the consumer member may also be measured and stored as the consumer member ID when biometrics (measurement of biological traits) is used to verify the consumer member.

Correlated and stored in the access permission table 12E are access key information generated by a processing routine (described later), consumer member IDs of certified consumer members, and conditions for permitting access to the database (e.g., corporation codes representing corporations which have been given permission to access personal credit information by the consumer members, a number of times access is permitted, a period during which access is permitted, and items to which access is permitted). When the conditions for permitting access become invalid due to, for example, the number of times access is permitted being exceeded or due to expiration of the period during which access is permitted, the database is updated by, for example, erasing the stored information, such as the access key information, the consumer member ID and the conditions for permitting access. When a specific corporation code is not set in the conditions due to an “all” designation being made to designate all corporations rather than a specific corporation, the database is updated so that the corporation code of the corporate member who first accessed the server by the access key is stored as the corporation code.

A corporate member ID for identifying a corporate member, a password, a corporation code, a URL (Uniform Resource Locator) of a homepage set up by the corporate member, and the like are stored in the corporate member management table 12F. The corporate member ID and the password are undisclosed data used in verifying the corporate member, and the corporation code is disclosed data used in designating the corporation to which access permission has been given.

The database 14 stores personal credit information corresponding to key information (name, date of birth, zip code, telephone number, consumer member ID, etc.) for identifying the consumer member. The personal credit information can be searched using the key information for identifying the consumer member.

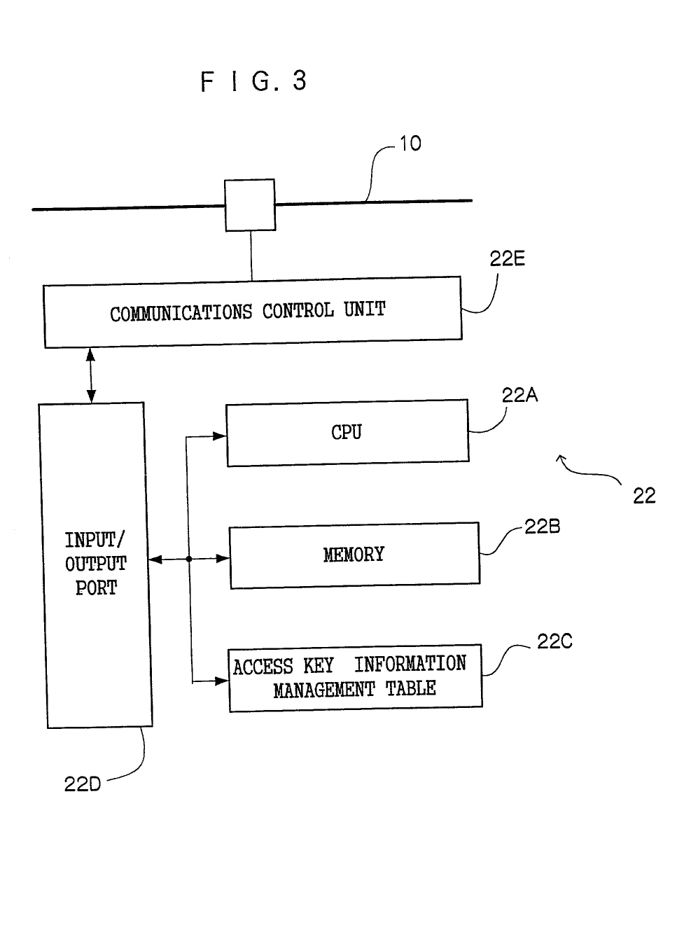

The consumer member client 22 includes, as shown in FIG. 3, a CPU 22A for controlling the entire client, a memory 22B disposed with a ROM in which a processing routine program is stored and a RAM used as a work area when the program is executed, an access key information management table 22C, and an input/output port 22D for input/output of data to and from each of the CPU 22A, the memory 22B, and the access key information management table 22C. The CPU 22A, the memory 22B, the access key information management table 22C, and the input/output port 22D are connected to one another through a bus.

The input/output port 22D is connected to the network 10 through a communications control unit 22E for communicating with, through the network 10, the electronic equipment, such as the server 12 or the client, connected to the network 10.

Correlated and stored in the access key information table 22C are corporation codes representing corporate members that permit access to the database, access key information, and a period during which access is permitted, which is one condition for permitting access set by the consumer member. The CPU 22A periodically checks whether the period during which access is permitted has expired, and updates the access key information management table 22C by, for example, erasing the corporation code for which the access permission period has expired and erasing the access permission period information for which the access key information has expired.

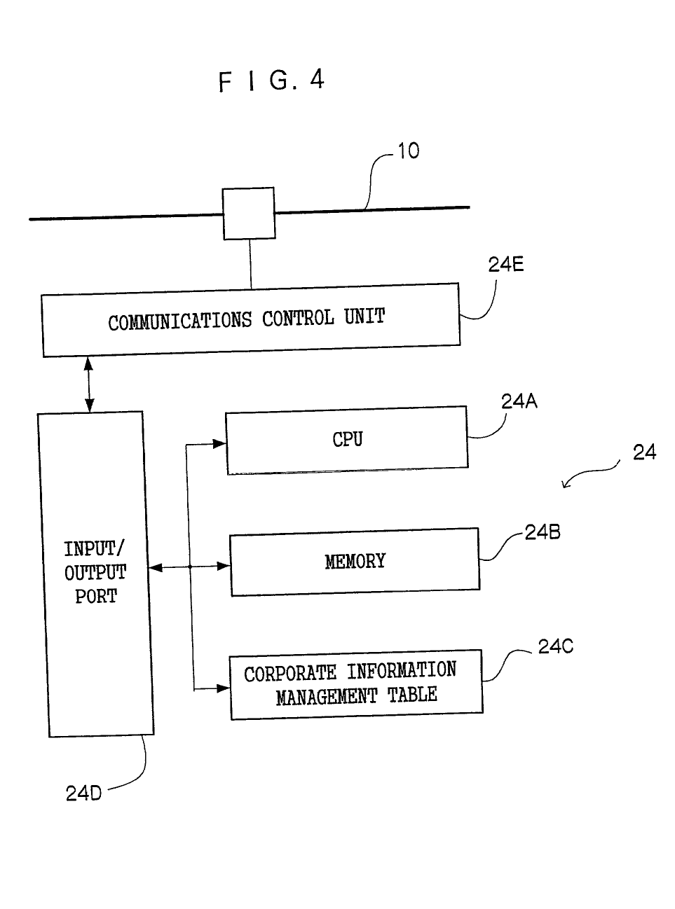

The corporate member server 24 includes, as shown in FIG. 4, a CPU 24A for controlling the entire client, a memory 24B disposed with a ROM in which a processing routine program and a RAM used as a work area when the program is executed, a corporate information management table 24C, and an input/output port 24D for input/output of data to and from each of the CPU 24A, the memory 24B, and the corporate information management table 24C. The CPU 24A, the memory 24B, the corporate information management table 24C, and the input/output port 24D are connected to one another through a bus.

The input/output port 24D is connected to the network 10 through a communications control unit 24E for communicating with, through the network 10, the electronic equipment, such as the server 12 or the client, connected to the network 10.

The corporation's own corporation code, the URL of the corporation's own homepage, other information necessary for corporate management and access key information transmitted from consumer members are stored in the corporate information management table 24C.

An Internet browser is installed in each of the consumer member client 22 and the corporate member server 24, and by using the browser, it is possible to connect to the server 12 through the network 10. At this time, the address of the server 12 is designated by the URL. When a request for access is received from the client, the server 12 transmits data of a position designated by the URL through the network 10 to the client. The data is generally transmitted in HTTP format. An IP address is used for identification of the client. Each of the server, the consumer member client, and the corporate member server is provided with a display device comprising a CRT or LCD for displaying various information and a printer for printing the displayed information.

Hereinafter, description will be given of processing routines executed with respect to each of the server 12, the consumer member client 22, and the corporate member server 24 in the system for accessing system to the database according to the present embodiment.

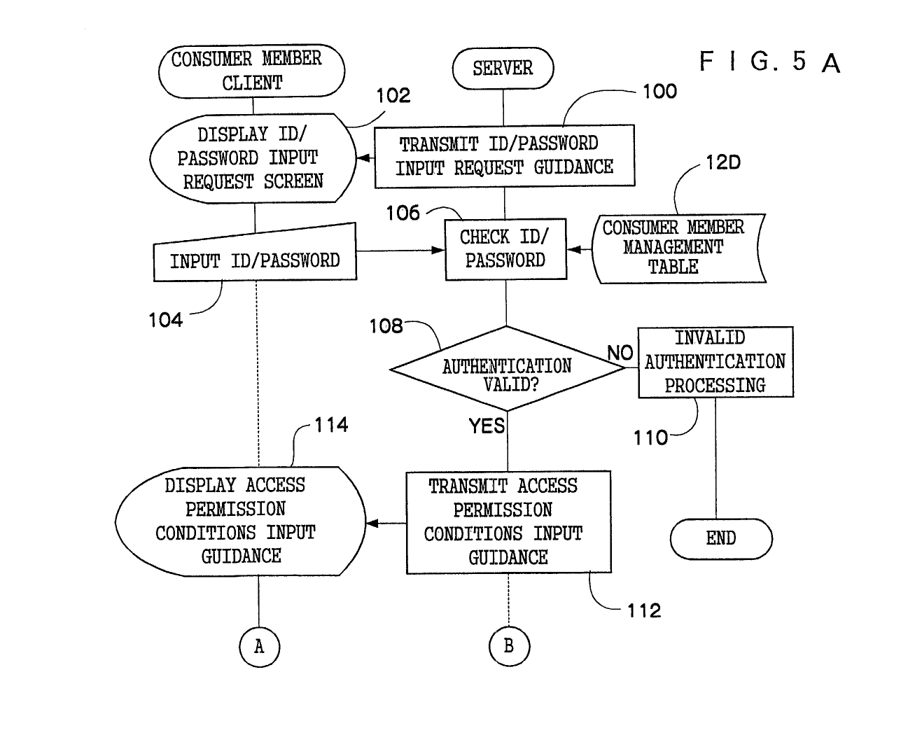

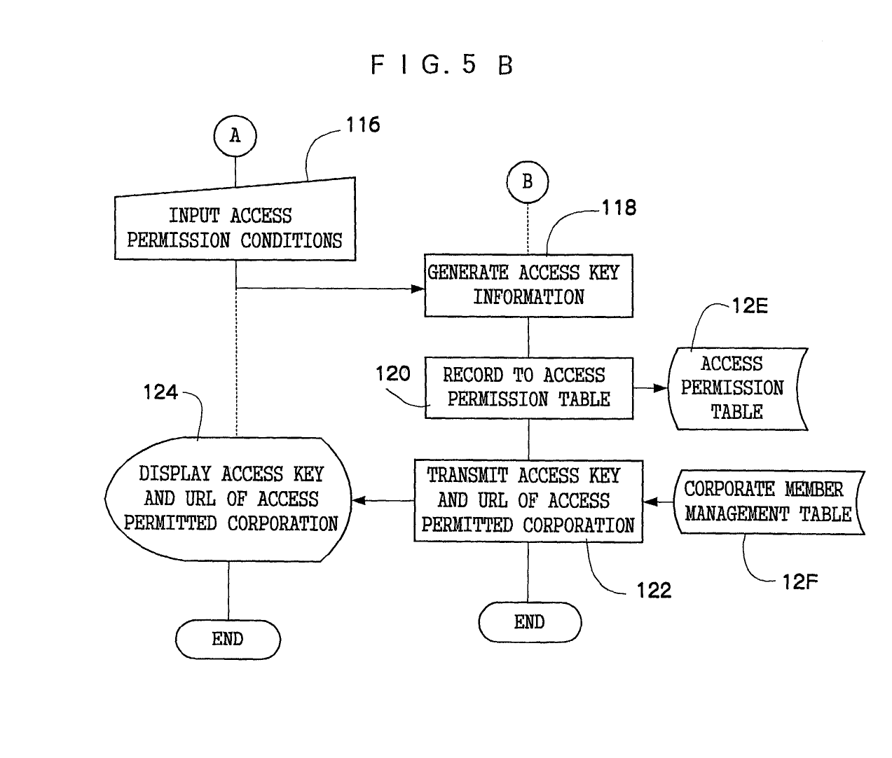

First, the process by which the access key information is acquired from the personal credit information agency by the consumer member will be described with reference to FIG. 5A and FIG. 5B.

The consumer member inputs the URL with the Internet browser to connect to the server 12 of the personal credit information agency, and requests acquisition of the access key information from the server 12.

At step 100, the server 12 transmits to the consumer member client 22 guidance information requesting the consumer member to input the consumer member ID and the password necessary to acquire the requested access key information.

At step 102, a screen provided with windows for inputting the consumer member ID and the password is displayed on the display device of the consumer member client on the basis of the guidance information received from the server 12. The consumer member inputs the consumer member ID and the password to the respective windows of the screen and clicks a transmission button provided on the screen, whereby the consumer member ID and the password are transmitted to the server 12.

At step 106, the server 12 checks the consumer member ID and the password transmitted from the consumer member client against the consumer member ID and the password registered in the consumer member management table 12D, and verifies whether the request for access is being made by the actual person whose ID is registered. On the basis of the results of step 106, it is determined in step 108 whether or not the consumer member requesting access is certified to access the database. When it is determined that the consumer member requesting access is not certified (i.e., when the inputted consumer member ID or password is invalid), at step 110, the consumer member may be asked to reenter the consumer member ID or password, or the consumer member client's connection with the server 12 may be cut.

When it is determined that the consumer member requesting access is certified to access the database (i.e., when the inputted consumer member ID and password are valid) at step 108, guidance information for inputting access permission conditions is transmitted to the consumer member client at step 112.

At step 114, a screen provided with a window for inputting the access permission conditions is displayed on the display device of the consumer member client on the basis of the guidance information received from the server 12. At step 116, the consumer member inputs the access permission conditions to the window of the screen and clicks a transmission button provided on the screen whereby the access permission conditions are transmitted to the server 12 and are set.

The access permission conditions (i.e., conditions for permitting access) comprise corporation codes representing corporations that have been given permission to access the database, a number of times access is permitted, a period during which access is permitted, and items to which access is permitted. At least one time can be set as the number of times access is permitted.

The access-permitted corporation may notify the consumer member of the corporation code in advance, for the consumer member to input the corporation code. Alternatively, the corporation code stored in the corporate member management table 12F of the server 12 may be transmitted to the consumer member client together with the guidance information for inputting access permission conditions, to then be selected and inputted by the consumer member.

Furthermore, input by the consumer member may be omitted by using defaults. For example, a default of one time may be set for the number of times access is permitted, a default of one week may be set for the period during which access is permitted and a default of specific items may be set for the items to which access is permitted.

Description has been given above of an example in which the corporation code, the number of times access is permitted, the period during which access is permitted and the items to which access is permitted are used as the conditions permitting access. However, any number of times access is permitted (for example, only one time), a combination of the number of times access is permitted and period during which access is permitted, a combination of the number of times of access is permitted and the items to which access is permitted, a combination of the number of times access is permitted, the period during which access is permitted, the items to which access is permitted, or a combination of these combinations and the corporation code can be used. However, it is preferable that at least the number of times access is permitted is included. Other conditions may be set as necessary.

When the access permission conditions are transmitted to the server 12, at step 118, access key information is generated. A random number of predetermined digits generated by the random number generator 12C can be used as the access key information. Alternatively, a number obtained by adding to the random number an issuance date of the access key information and a sequential number assigned to the issue date may be used as the access key information. Further still, a hash value obtained by further processing the access key information itself, which was generated in the manner described above, by a hash function may be used as the access key information.

The method of generation of the access key information is not limited to the above-described method. In accordance with the demand of access key information and the number of consumer members, a more secure method can be suitably selected. The access key information can also be generated when the access conditions are transmitted to the server by push-phone signals through the automated response center 18.

At step 120, the generated access key information, together with the consumer member ID and the access permission conditions transmitted from the consumer member client, are recorded in the access permission table 12E. Accordingly, the access key information, the consumer member ID, the access-permitted corporation code, the number of times access is permitted, the period during which access is permitted, the items to which access is permitted and the like are correlated with one another and are stored in the access permission table 12E.

At step 122, the access key information generated at step 118, and the URL of the corporation set by the corporation code in the access permission conditions and searched from the corporate member management table 12F are transmitted to the consumer member client. At step 124, since the access key information and the URL of the corporation are displayed on the display screen of the consumer member client, the consumer member acquires the access key information, and can easily connect to the homepage of the corporation permitted to access the personal credit information agency. The acquired access key information can be recorded on a memo or the like, or can be stored in the access key management table 22C.

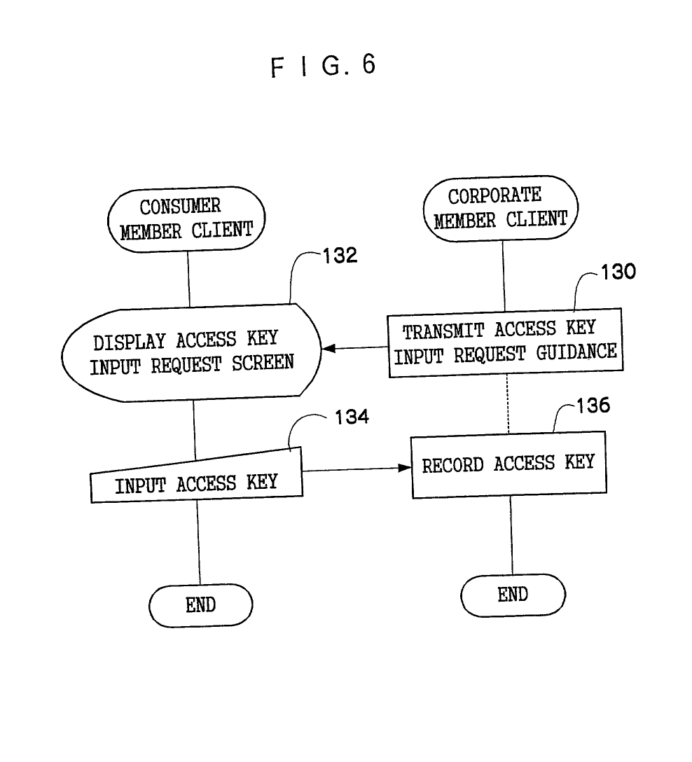

Next, the process by which access key information is supplied from the consumer member to the corporate member will be described with reference to FIG. 6.

When the consumer member connects to the homepage of the access-permitted corporation, at step 130, guidance information for requesting the input of access key information is transmitted from the corporate member server 24 to the consumer member client 22. At step 132, an input request screen for inputting the access key information is displayed on a display device of the consumer member client 22. After the access key information is inputted in accordance with the guidance displayed on the input request screen at step 134 and a transmission button is clicked, the access key information is transmitted to the corporate member server 24 and is stored in the memory 24B provided in the corporate member server 24 at step 136. Thus the access key information is supplied to the corporate member, and the corporate member can use the access key information.

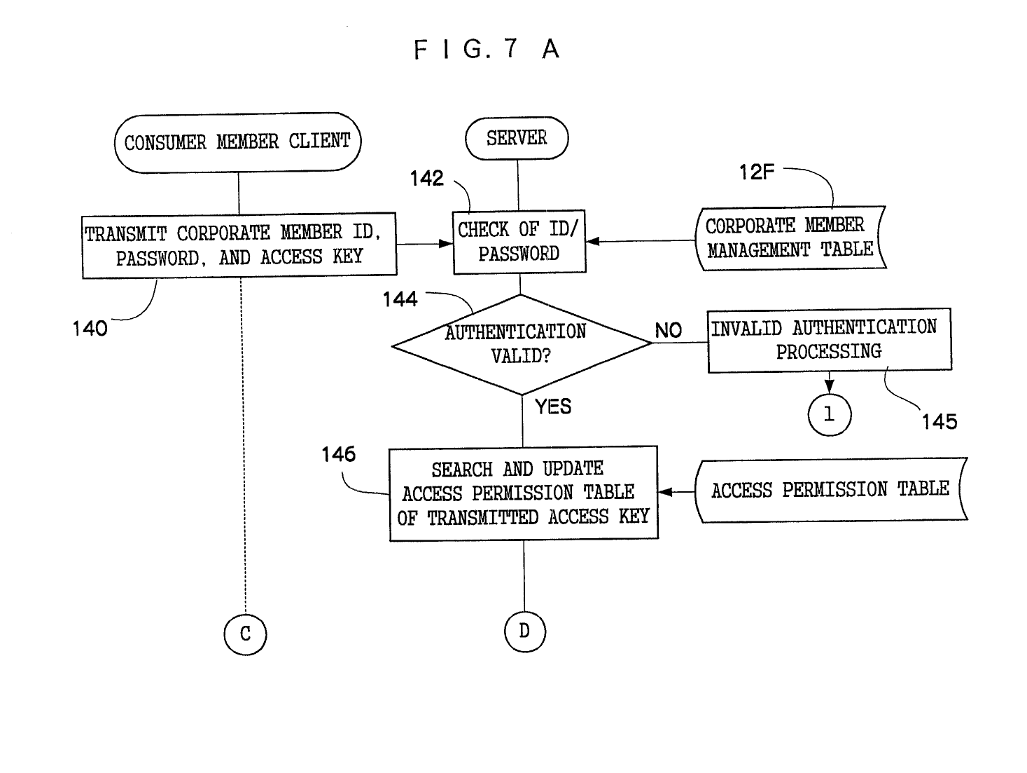

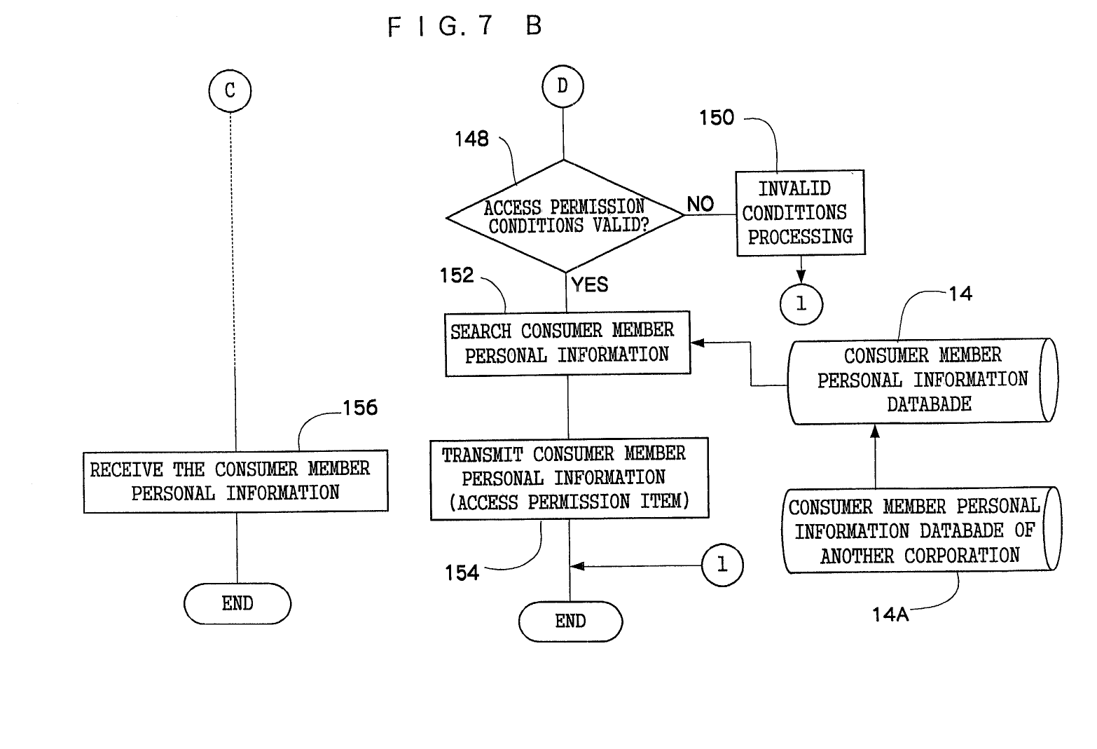

Next, the process by which the corporate member provided with the access key information acquires the personal credit information of the consumer member from the database of the personal credit information agency will be described with reference to FIG. 7A and FIG. 7B.

The corporate member used the Internet browser to connect to the homepage of the personal credit information agency that is stored in the server 12, and requests access to the database. Guidance information is the transmitted from the server 12 to the corporate member server 24, and an input screen for inputting necessary items is displayed on the display device of the corporate member server 24. By using this input screen at step 140, the corporate member inputs the corporate member ID, the password, and the access key information, which are then transmitted to the server 12.

At step 142, the server 12 checks the corporate member ID and the password transmitted from the client of the corporate member against the corporate member ID and the password registered in the corporate member management table 12F, and verifies whether the access is being made from the registered corporation. On the basis of the results of step 142, it is determined in step 144 whether or not the corporate member requesting access is certified to access the database. When it is determined that the corporate member requesting access is not certified (i.e., when the inputted corporate member ID or password is invalid), at step 146, the corporate member may be asked to reenter the corporate member ID or password, or the corporate member's connection with the server may be cut.

When it is determined that the corporate member requesting access is certified to access the database (i.e., when the inputted corporate member ID and password are valid), at step 146, the access key information transmitted from the corporate member is searched by referring to the access permission table 12E in which the access key information is recorded, and the access permission table is updated. when a specific corporation code is not designated in the access permission table because of an “all” designation, the code of the corporate member who first accessed the server is stored (updated) as the corporation code, and when the number of times in which access is permitted is set, the number of times of access permission is decremented by one each time access is verified. When the conditions for permitting access become invalid due to, for example, the number of time access is permitted being exceeded or due to expiration of the period during which access is permitted, the conditions are updated by, for example, erasing the stored conditions.

At step 148, it is determined whether the request for access by the corporate member satisfies the conditions before the update. When the access condition permissions are not satisfied, for example, the connection with the corporate member server may be cut at step 150.

At step 148, when it is determined that the access permission conditions are satisfied, at step 152, key information (name, date of birth, zip code, telephone number, consumer member ID, etc.) for identifying the consumer member is automatically extracted, and personal credit information corresponding to the key information is searched from the database 14 in which the personal credit information is made to correspond to the key information for identifying the consumer member and is stored.

As shown in FIG. 7A and 7B, the database 14 managed by the server 12 (i.e., the database managed by the corporation itself) is linked with a database 14A managed by another server (i.e., a database managed by another corporation) and in which personal credit information of consumer members is stored. Key information for identifying the consumer members of the database 14A of the other corporation is stored in the database 14, so that the personal credit information can also be searched from the database 14A of the other corporation. When the personal credit information is searched from the database 14A of the other corporation, it is also possible to reply to the corporate member server 24 by adding the personal credit information searched from the database 14 to the personal credit information searched from the database 14A of the other corporation.

When the personal credit information corresponding to the items to which access is permitted set in the access permission conditions is transmitted to the corporate member server 24 at step 154, the personal credit information transmitted from the server 12 is received at step 156 by the corporate member server 24 and is displayed on the display device.

Description has been given above of an example in which the access key information is provided from the consumer member client 22 to the corporate member server 24 through the network 20. However, as described in a second embodiment below, the access key information may be automatically provided by using an access key information management table.

In the second embodiment, the access key information management table is previously provided in a consumer member client or an external storage device, such as an IC card, connected to the consumer member client. The access-permitted corporation code, access key information, and access permission period information are stored in the access key information management table.

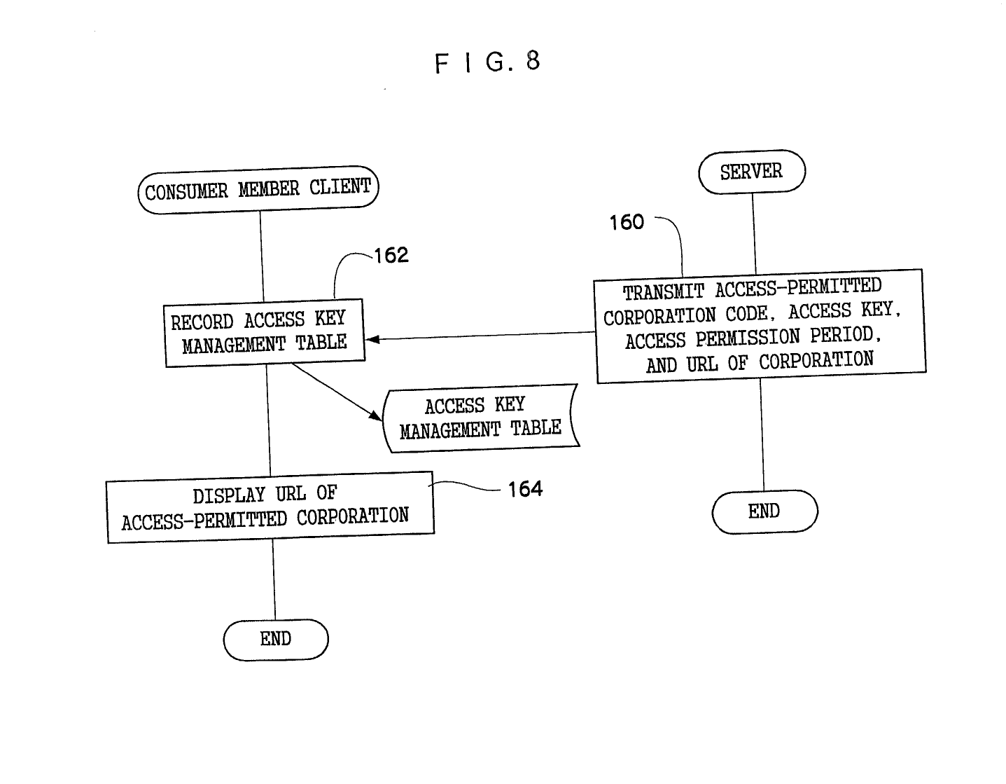

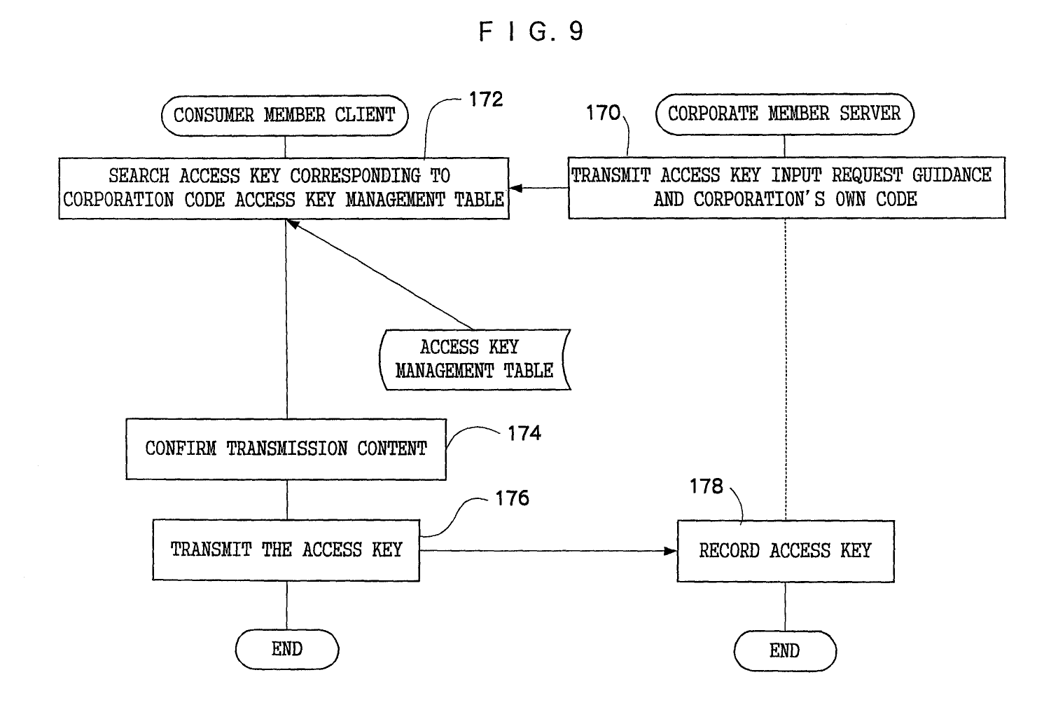

Hereinafter, a processing routine of the second embodiment will be described with reference to FIG. 8 and FIG. 9. Illustration of steps showed in common with the first embodiment is omitted.

As described in the first embodiment, when a consumer member has been verified access permission conditions are set by the consumer member client 22 and access key information is generated and registered in an access permission table (step 100 to step 120). At step 160, a URL of an access-permitted corporation, an access-permitted corporation code set by the access permission conditions, access key information, and access permission period information are transmitted from the server 12 to the consumer member client 22.

When the URL of the access-permitted corporation and the access-permitted corporation code are transmitted from the server 12, a consumer member ID and a password are inputted by the consumer member client 22 at step 162, whereby it is verified whether the consumer member client 22 has the right to register to the access key information management table 22C. When the member is verified the information transmitted from the server in the access key information management table 22C is registered.

At next step 164, since the URL of the access-permitted corporation is displayed on the display device of the consumer member client 22, the consumer member acquires the access key information and can easily connect to the homepage of the corporation permitted to access the personal credit information agency.

When the consumer member connects to the displayed URL, at step 170 of FIG. 9, guidance information for requesting the input of access key information and the corporation's own code are transmitted from the corporate member server 24 to the consumer member client 22. At step 172, since the input request screen for inputting the access key information and the received corporation code are displayed on the display device of the consumer member client 22, verification similar to that described above is carried out. When verified, the access key information corresponding to the corporation code received from the access key information management table is searched and is displayed on the input request screen.

When the corporation code is not registered and the corporation code of the access key information management table is an “all” designation, the access key information corresponding to the “all” designation is searched and is displayed.

At step 174, the transmission description displayed on the input request screen is confirmed, and when a transmission button is clicked at step 176, the access key information is transmitted to the corporate member server 24 and is stored in the memory provided in the corporate member server 24 at step 178. Thus, the access key information is provided to the corporate member.

In the above embodiments, description has been given of an example in which, when the access key information is acquired by the consumer member, connection to the homepage provided in the server 12 is made with the Internet browser (including the browser a portable terminal such as a portable telephone), and the consumer member ID and the password are inputted and displayed on the browser so that the access key information is acquired. However, the access key information may be acquired by the following methods. In a first method, a consumer member ID and a password are electronically transmitted to an e-mail address provided in a server (including a mailer for a portable terminal such as a portable telephone), and access key information is acquired through the Internet. In a second method, a call is made to an automated response center of a personal credit information agency, necessary items are inputted with push-phone tone signals in accordance with instructions from a voice automated response device, and access key information is acquired through the voice response. In a third method, when the consumer member uses a terminal device, such as a computer, capable of two-way communication with a terminal device, such as a computer, of a personal credit information agency, access key information is acquired by using this terminal device. In a fourth method, a letter containing necessary information such as a consumer member ID and a password is sent by facsimile or mail, or is directly delivered personally to an operator of a personal credit information agency, and access key information is acquired by facsimile, mail or direct personal delivery.

As methods of providing the access key information to the corporate member, in the above, description has been given of methods in which access to the homepage of the corporate member is made with an Internet browser (including the browser of a portable terminal such as a portable telephone) and the access key information is inputted to be provided. However, the access key information may be provided to the corporate member by the following methods. In a first method, access key information is electronically transmitted to an e-mail address of a corporate member by Internet mail (including a mailer for a portable terminal such as a portable telephone). In a second method, a call is made to an automated response center of a corporate member, necessary items are inputted with push-phone tone signals in accordance with guidance of a voice automatic response device, and access key information is provided through the voice response. In a third method, when a consumer member possesses a terminal device, such as a computer, connected to a terminal device, such as computer, of a corporate member through a communication line, access key information is provided using this terminal device. In a fourth method, a letter containing access key information is provided by facsimile, mail, or direct personal delivery.

As described above, according to the present invention, the access key information and the access permission condition are set to permit access to the database, whereby labor is saved and access to the database storing personal information can be made from the outside without invading the privacy of an individual.

What is claimed is:

1. A system for permitting access to a database, the system comprising:
a database manager, wherein access key information that is used as a key for accessing personal information stored in the database and conditions for permitting access to the database are preset, and when a request for access to the database is made, it is determined whether or not the preset access key information matches the access key information used in the request, with access to the database being permitted when the access key information matches the access key information used in the request and the conditions for permitting access are satisfied; and
a setting unit for setting the access key information and the conditions in the database manager.

2. The system of claim 1, wherein the access key information is acquired by a consumer client from a predetermined agency, is transmitted from the consumer client to a corporate server, and is used by the corporate server to access the database.

3. The system of claim 1, wherein the personal information includes personal credit information.

4. The system of claim 1, wherein the conditions comprise at least one of:
a code representing a corporation that is permitted to access;
a number of times access is permitted;
a period during which access is permitted; and
an item to which access is permitted.

5. A method for accessing a database in which personal information is stored, the method comprising the steps of:
presetting access key information that is used as a key for accessing the database and conditions for permitting access to the database;
determining, when a request for access is made, whether access key information used in the request matches the preset access key information and whether the conditions for permitting access are satisfied; and
permitting access to the database when the access key information used in the request matches the preset access key information and when the conditions for permitting access are satisfied.

6. The method of claim 5, wherein the access key information is acquired by a consumer client from a predetermined agency, is transmitted from the consumer client to a corporate server, and is used by the corporate server to access the database.

7. The method of claim 5, wherein the personal information includes personal credit information.

8. The method of claim 5, wherein the conditions comprise at least one of:
a code representing a corporation that is permitted to access;
a number of times access is permitted;
a period during which access is permitted; and
an item to which access is permitted.

9. A database manager comprising:
a storage for presetting and storing access key information that is used as a key for accessing a database and conditions for permitting access to the database;
a decider for determining, when a request for access is made, whether access key information used in the request matches the preset access key information and whether the conditions for permitting access are satisfied; and a permit device for permitting access to the database when the access key information used in the request matches the preset access key information and when the conditions for permitting access are satisfied.

10. The database manager of claim 9, wherein the access key information is acquired by a consumer client from a predetermined agency, is transmitted from the consumer client to a corporate server, and is used by the corporate server to access the database.

11. The database manager of claim 9, wherein the database manager links the database in which the database manager is disposed with another database, and the permit device permits access to the other database when access key information used in the request matches the preset access key information and when the conditions for permitting access are satisfied.

12. The database manager of claim 9, wherein the personal information includes personal credit information.

13. The database manager of claim 9, wherein the conditions comprise at least one of:
a code representing a corporation that is permitted to access;
a number of times access is permitted;
a period during which access is permitted; and
an item to which access is permitted.

14. A consumer client comprising:
a receiver for receiving from a predetermined agency access key information used in a database manager, wherein access key information that is used as a key for accessing a database and conditions for permitting access to the database are preset in the database manager, with the database manager determining, when a request for access is made, whether access key information used in the request matches the preset access key information and whether the conditions for permitting access are satisfied, and with the database manager permitting access to the database when the access key information used in the request matches the preset access key information and when the conditions for permitting access are satisfied; and
a transmitter for transmitting the access key information received from the predetermined agency to a corporate server.

15. The consumer client of claim 14, further comprising an access key information table for storing the access key information received from the predetermined agency, with the access key information received from the predetermined agency being automatically transmitted to the corporate server using the access key information table.

16. The consumer client of claim 14, wherein the personal information includes personal credit information.

17. The consumer client of claim 14, wherein the conditions comprise at least one of:
a code representing a corporation that is permitted to access;
a number of times access is permitted;
a period during which access is permitted; and
an item to which access is permitted.

18. A corporate server comprising:
a receiver for receiving from a consumer client access key information used in a database manager, wherein access key information that is used as a key for accessing a database and conditions for permitting access to the database are preset in the database manager, with the database manager determining, when a request for access is made, whether access key information used in the request matches the preset access key information and whether the conditions for permitting access are satisfied, and with the database manager permitting access to the database when the access key information used in the request matches the preset access key information and when the conditions for permitting access are satisfied; and
an access device for accessing the database by using the access key information received from the consumer client.

19. The corporate server of claim 18, wherein the personal information includes personal credit information.

20. The consumer client of claim 18, wherein the conditions comprise at least one of:
a code representing a corporation that is permitted to access;
a number of times access is permitted;
a period during which access is permitted; and an item to which access is permitted.
